(19) United States
(12) Patent Application Publication
(10) Pub. No.: US 2002/0021984 A1
(43) Pub. Date: Feb. 21, 2002

(54) Device for methane-free hydrocarbon measurement

(76) Inventor: Armin Kroneisen, Frankfurt (DE)

Correspondence Address: Michael M. Rickin, ABB Automation Inc., 29801 Euclid Avenue - 4U6, Wickliffe, OH, 44092-1898, US

(21) Appl. No.: 09/837,048

(22) Filed: Apr. 18, 2001

Related U.S. Application Data
(62) Division of application No. 09/422,600, filed on Oct. 21, 1999.

(30) Foreign Application Priority Data
Oct. 24, 1998 (DE) 19849105.0

(51) Int. Cl. G01N 31/10

(52) U.S. Cl. 422/83; 422/54

(57) ABSTRACT

A device for methane-free hydrocarbon measurement in combustion exhaust gases using the flame ionization technique. In order to refine the device, in such a way that optimum oxidation is possible even when the composition of the gas to be measured experiences fluctuations and, in addition, equipment outlay is minimized, extra oxygen and/or extra hydrogen is supplied to the gas to be measured before the oxidation catalysis.

### CROSS REFERENCE TO RELATED APPLICATIONS

This application is a divisional of U.S. patent application Ser. No. 09/422,600 filed on Oct. 21, 1999.

### FIELD OF THE INVENTION

The present invention relates to a device for measuring the hydrocarbon content of an exhaust gas and more particularly to the technique known as flame ionization for making such measurement.

### DESCRIPTION OF THE PRIOR ART

In the flame ionization technique the measurement of hydrocarbons, such as those that are produced in industrial off gases or automobile exhaust gases, is carried out with the aid of so-called flame ionization detectors (FIDs). Hydrocarbons with an extremely wide variety of compositions occur in such exhaust gases. A predominant proportion of the total hydrocarbon consists of methane. However, unlike many other hydrocarbon compounds, methane does not directly cause any short-term or long-term harm. Consequently, the intentional measurement of industrial off gases and automobile exhaust gases in terms of their methane content is of no particular importance.

Particular attention is paid to the hydrocarbon compounds which are produced whenever inefficient combustion takes place in industrial systems or in automobiles. In this context, only the hydrocarbons other than methane play a role relevant to the environment, and therefore relevant to health issues. For the most part, these combustion processes need to be monitored, in particular, because of environmental requirements.

Thus, in particular in the case of elaborate large-scale combustion systems, as in industry, sometimes elaborate in-line measuring systems are installed in order to optimize the combustion. In this regard, optimizing the combustion means that there is complete combustion, in which substantially complete oxidation of the hydrocarbon compounds also takes place.

In principle, combustion systems as are to be found in industry are subject to monitoring. In that regard, it is in the interest of any combustion system operator, or even anyone running an industrial concern, for the exhaust gases to lie within legal standards. To that end, the combustion processes are, as mentioned above, monitored on-line. The measurement results during the on-line monitoring are then taken into account to the extent that the combustion parameters are controlled on the basis of these ascertained values.

The catalytic converter systems which are now legally required in automobiles are another application case for on-line regulation of combustion. By means of this, particular substances, or possibly essentially even only temperature, are measured and the combustion, that is to say the air/fuel composition, is controlled on this basis in such a way that there is optimized and therefore substantially complete combustion.

As mentioned above, normal combustion gases contain hydrocarbons, of which by far the greatest portion consists of methane. Since, however, methane plays only a very minor role in the monitoring of combustion systems, it is important to separate the other hydrocarbon signals from the methane signal.

To that end, an arrangement is usually selected in which two detectors, for example two flame ionization detectors, are operated in parallel. An oxidation catalyst is connected upstream of one of the two flame ionization detectors, but not of the other. On that path for the gas to be measured which is supplied to the flame ionization detector without an oxidation catalyst, the sum of all hydrocarbons is therefore measured, that is to say the total signal ascertained there contains all hydrocarbons, and therefore also the by far predominant methane.

In the second path for the gas to be measured, as mentioned above, an oxidation catalyst is connected upstream of the second flame ionization detector. In this oxidation catalyst, which is normally heated to a working temperature of generally about 250° C., all the hydrocarbons apart from methane are oxidized to form carbon dioxide and water. At the outlet of the oxidation catalyst, only methane therefore still remains as a representative of the hydrocarbons. This methane is then supplied to the second flame ionization detector and provides there the correspondingly proportional methane signal.

The two signals, from the first and second flame ionization detectors, are then electronically combined and their difference is taken. The signal found by subtraction is therefore the non-methane hydrocarbon signal. In other words, this means that, using this detector or measuring arrangement, the otherwise high offset due to methane is separated from the other hydrocarbon signals. This means that what remains is the sum of all hydrocarbons apart from methane. This measurement result is then in turn of great interest in terms of the environmentally friendly combustion mentioned above, because only the hydrocarbons apart from methane play a role relevant to the environment, and therefore to health issues. The measurement signals for the hydrocarbons which are of such interest are in this case thus separated from the relatively large methane-induced offset.

Particular attention is in this regard paid to the operation of the catalyst. In such a catalyst, operating states can occur in which the oxygen needed for the oxidation of the hydrocarbons is only insufficiently present, or even completely absent, in the gas to be measured. Owing to this, the hydrocarbons are converted into tarry products which stick to the active surface of the catalyst. The efficiency of the catalyst is therefore rapidly reduced. Regeneration is partially possible at high temperatures, for example above 600° C., with air or oxygen, but requires two catalyst elements so that the measurement operation can continue without interruption during the regeneration phase of one of said elements. This redundant layout of the catalyst arrangement is, on the one hand, expensive and, on the one hand, very difficult to control successfully in terms of equipment. It is important to point out here that, for the operation of conventional systems, only the gas to be measured is available for the oxidation, and a precondition is that sufficient oxygen is at least to some extent present in this gas. However, this is not so in many cases.

On the basis of the foregoing the present invention refines a process as well as a device of the generic type, in such a way that optimum oxidation is possible even when the composition of the gas to be measured experiences fluctuations and, in addition, equipment outlay is minimized.

In accordance with the present invention oxygen or air is supplied to the gas to be measured in the region of the oxidation catalyst, that is to say in the path which the gas to be measured takes to the oxidation catalyst. The effect of this is to ensure that optimum oxidation is always guaranteed by an amount of oxygen which is in principle sufficient. The aforementioned disadvantages caused by clogging of the catalyst are thereby avoided. The result obtained by this is in turn that the catalyst arrangement does not need to be given a redundant layout. Further, hydrogen may be supplied either on its own or else together with the oxygen. In the latter case, this leads to the result of postcatalytic water formation.

### SUMMARY OF THE INVENTION

A device for measuring residual hydrocarbon content of a gas. The device comprises:

a) two flame ionization detectors connected in parallel in terms of the flow of the gas to be measured with an inlet for the gas to be measured;

b) one of the two flame ionization detectors having the gas to be measured applied directly to it;

c) an oxidation catalyst connected upstream of the other of the two flame ionization detectors; and

d) a gas supply line carrying extra oxygen and/or hydrogen after the inlet to the oxidation catalyst.

### DESCRIPTION OF THE DRAWING

FIG. 1 shows an embodiment for the addition of air according to the present invention.

FIG. 2 shows a device for hydrocarbon measurement embodied with the interconnection of two FIDs in accordance with the prior art.

### DESCRIPTION OF THE PREFERRED EMBODIMENT(S)

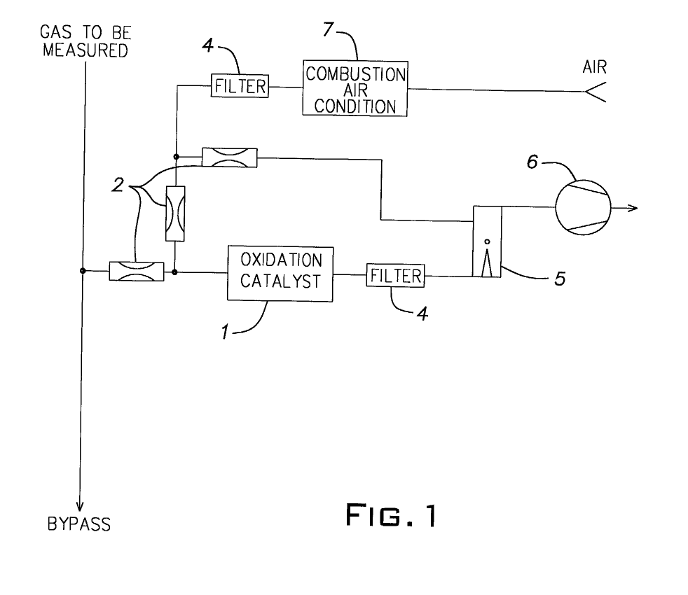

FIG. 1 shows the addition of air according to the invention on that path for the gas to be measured, or that FID measurement path, upstream of which the oxidation catalyst 1 is connected. In this case, air is supplied to a combustion-air conditioning system 7 and fed after this through a filter 4. From there on, a bypass is provided which, on the one hand, supplies the combustion air via a nozzle or capillary 2 directly to the FID 5 and, on the other hand, supplies the combustion air through another nozzle 2, in parallel with the supply of gas to be measured, to the oxidation catalyst 1. This means that air, or to be more precise the oxygen which it contains, is supplied to the gas to be measured. The combustion air supplied before the oxidation stage, or the oxygen which it contains, causes substantial, complete oxidation of the hydrocarbons in the oxidation catalyst.

Owing to this effect, extra oxygen is added to the gas to be measured, and this leads to the hydrocarbons being oxidized as completely as possible to form carbon dioxide and water. In this case, the oxidation affects all hydrocarbons apart from methane. This means that methane will pass through the oxidation catalyst and be supplied through a filter to the FID. The methane content thus in the gas to be measured is then ascertained by means of the FID. The oxidation catalysis of the other hydrocarbons is in this case so complete that the disadvantages described above are avoided and the catalyst is not clogged up.

In a practical example, automobile exhaust gas contains, as gas for the FID to measure, a maximum hydrocarbon value of around 10 000 ppm, measured as C₃. From the combustion air conditioned free of hydrocarbons for the FID, air at a level of about 25% was added to the gas to be measured. The minimum oxygen level of about 5% obtained in this way is sufficient for complete combustion of the hydrocarbons in the catalyst. The feared tarring or clogging of the active surface of the catalyst is thereby avoided and a regeneration device which, as described above, would need to be given a redundant layout, is therefore no longer necessary.

The proposed constant dilution of the gas to be measured is automatically taken into account during the calibration of the measuring device, and therefore does not lead to any measurement error.

A further possible example could consist in apportioning 100% pure oxygen, instead of the air to be added, to the gas to be measured before the catalyst. The effect is to reduce the degree of dilution of the gas to be measured by a factor of 5, since air contains only about 20% oxygen. Instead of dilution by 25%, dilution by only 5% then takes place.

This process is advantageous whenever the methane content to be determined is very low and the detection limit of the FID is no longer sufficient for an unimpaired recording of the methane.

A suction pump 6, which takes the gas into the measuring unit, that is to say the FID, is arranged downstream of the FID 5.

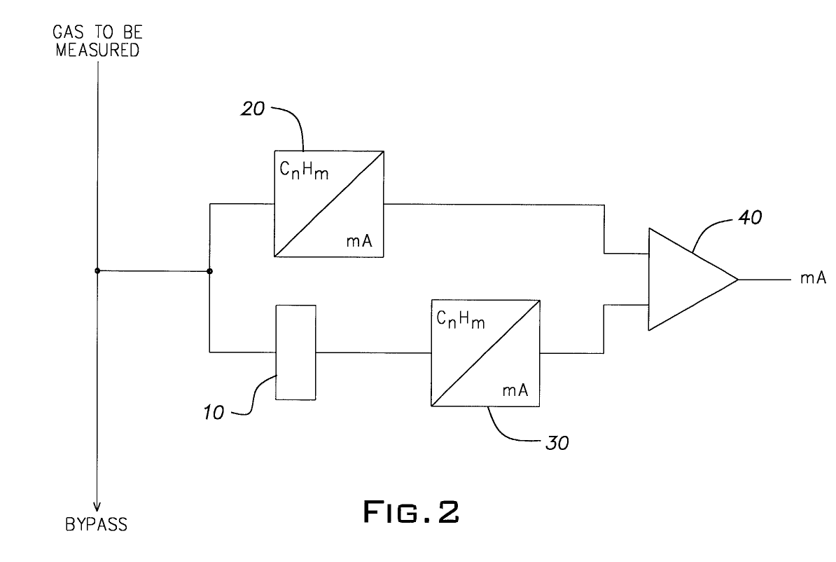

FIG. 2 shows a structure as is generally used in the prior art for methane-free hydrocarbon measurement and which is the starting point of the present invention. In this case, the gas to be measured is divided into two sub-paths, a respective flame ionization detector 20, 30 being arranged in each of the sub-paths. In the upper flame ionization detector 20, the sum of all hydrocarbons is ascertained, that is to say the total signal inclusive of the methane which it predominantly contains, as described above.

In the lower sub-path of the feed for the gas to be measured, there is a second flame ionization detector, upstream of which an oxidation catalyst 10 is connected. This oxidation catalyst oxidizes all hydrocarbons from the gas to be measured, apart from methane. At the outlet of the oxidation catalyst, in terms of hydrocarbon compounds only the methane is then available, and this is supplied to the second flame ionization detector 30. The value ascertained there corresponds to the methane content in the gas to be measured.

The two output electrical signals, which are proportional to the measurement effect, from the two flame ionization detectors are processed in an appropriate electronic subtraction circuit 40 for the purpose of taking the difference, and the isolated methane signal is then subtracted from the sum of all signals proportional to hydrocarbons inclusive of the methane signal. From the difference, a signal is therefore formed which is proportional to the non-methane residual hydrocarbon content. This measurement arrangement is conventional and suffers from the disadvantages described above from the prior art.

The difference between such an arrangement from the prior art according to FIG. 2 and the arrangement according to the invention according to FIG. 1 is the integration of the further oxygen and/or hydrogen supply described with reference to FIG. 1. The integration according to the invention then consists in organizing the addition of air or oxygen, and/or if appropriate the addition of hydrogen, on the measurement path which contains the oxidation catalyst, so that complete oxidation of all hydrocarbons apart from methane is ensured, as shown by FIG. 1.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A device for measuring residual hydrocarbon content of a gas comprising:
a) two flame ionization detectors connected in parallel in terms of the flow of said gas to be measured with an inlet for said gas to be measured;
b) one of said two flame ionization detectors having said gas to be measured applied directly to it;
c) an oxidation catalyst connected upstream of the other of said two flame ionization detectors; and
d) a gas supply line carrying extra oxygen and/or hydrogen after said inlet to said oxidation catalyst.

2. The device of claim 1 wherein said gas supply line carrying said extra oxygen and/or hydrogen contains a bypass which is directly connected after said inlet to said other of said two flame ionization detectors.

3. The device of claim 1 wherein both said gas to be measured and said extra oxygen and/or extra hydrogen are taken in by a suction pump which is downstream of said flame ionization detectors.

4. The device of claim 2 wherein both said gas to be measured and said extra oxygen and/or extra hydrogen are taken in by a suction pump which is downstream of said flame ionization detectors.

5. The device of claim 1 further including a supply line for said gas to be measured and wherein said supply line for said gas to be measured and said gas supply line carrying extra oxygen and/or extra hydrogen each include a flow resistance.

6. The device of claim 2 further including a supply line for said gas to be measured and wherein said supply line for said gas to be measured and said gas supply line carrying extra oxygen and/or extra hydrogen each include a flow resistance and said bypass also includes a flow resistance.

7. The device of claim 3 further including a supply line for said gas to be measured and wherein said supply line for said gas to be measured and said gas supply line carrying extra oxygen and/or extra hydrogen each include a flow resistance.

8. The device of claim 4 further including a supply line for said gas to be measured and wherein said supply line for said gas to be measured and said gas supply line carrying extra oxygen and/or extra hydrogen each include a flow resistance and said bypass also includes a flow resistance.

9. The device of claim 5 wherein said flow resistances are designed as nozzles or capillaries and can be adjusted relative to one another.

10. The device of claim 6 wherein said flow resistances are designed as nozzles or capillaries and can be adjusted relative to one another.

11. The device of claim 7 wherein said flow resistances are designed as nozzles or capillaries and can be adjusted relative to one another.

12. The device of claim 8 wherein said flow resistances are designed as nozzles or capillaries and can be adjusted relative to one another.
